(19) United States
(12) Patent Application Publication
(10) Pub. No.: US 2025/0278840 A1
(43) Pub. Date: Sep. 4, 2025

(54) Boundry Line Detection Device and Method

(71) Applicant: LG Energy Solution, Ltd., Seoul (KR)

(72) Inventors: Shikwon Kim, Daejeon (KR); Yeongeun Cha, Daejeon (KR)

(73) Assignee: LG Energy Solution, Ltd., Seoul (KR)

(21) Appl. No.: 18/862,307

(22) PCT Filed: Aug. 30, 2023
(86) PCT No.: PCT/KR2023/012877

§ 371 Date: Nov. 1, 2024

(30) Foreign Application Priority Data
Aug. 31, 2022 (KR) 10-2022-0109764
Aug. 9, 2023 (KR) 10-2023-0103920

(51) Int. Cl. G06T 7/13

(52) U.S. Cl. CPC G06T 7/13

(57) ABSTRACT

An edge detection apparatus and method according to embodiments of the present invention may acquire a first electrode image and a second electrode image with different brightness values in which a same electrode is captured, and detect final edges of an uncoated portion from the second electrode image based on pixel coordinate information of edges of the uncoated portion obtained from the first electrode image, thereby improving detection accuracy of edge detection.

### CROSS-REFERENCE TO RELATED APPLICATION

The present application is a national phase entry under 35 U.S.C. § 371 of International Application No. PCT/KR2023/012877 filed Aug. 30, 2023, which claims priority from Korean Patent Application No. 10-2022-0109764 filed in the Korean Intellectual Property Office on Aug. 31, 2022 and Korean Patent Application No. 10-2023-0103920 filed in the Korean Intellectual Property Office on Aug. 9, 2023, the entire contents of which are incorporated herein by reference.

### TECHNICAL FIELD

The present invention relates to an apparatus and method for detecting edges of battery electrodes, and more particularly, to an apparatus and method for detecting edges of uncoated portions on electrode images.

### BACKGROUND

As the price of energy sources rises due to depletion of fossil fuels and interest in environmental pollution increases, a demand for secondary batteries as an eco-friendly alternative energy source is rapidly increasing.

Lithium secondary batteries among secondary batteries are being applied to various industrial fields from as well as mobile application devices to automobiles, robots, and energy storage devices, as a response to today's environmental regulations and high oil price issues.

These lithium batteries are generally classified into cylindrical, prismatic, or pouch types depending on the shape of the exterior material in which the electrode assembly is accommodated.

Among these, cylindrical batteries may be provided in a form where the electrode assembly is inserted inside the battery can along with the electrolyte.

An electrode constituting an electrode assembly can be divided into an electrode portion, which is an area coated with positive and negative electrode active materials, and an uncoated portion which is an area where the electrode active material is not coated.

Generally, during a slitting process, electrodes are cut to a certain size to fit the size of a battery can.

Here, in order to measure widths of the electrode portion and the uncoated portion of the electrode which is inserted into the battery can and cut the electrode uniformly, it is necessary to clearly detect the edge dividing the electrode portion and the uncoated portion.

A conventional edge detection device adjusts an exposure value of a camera so that a brightness pixel value (Gray Value) of the uncoated region is 255 and detects the edges of the uncoated portion based on the electrode image captured by the camera.

More specifically, a conventional edge line detection device detects at least one pixel having a brightness value that differs by more than a threshold value from a brightness value of a single pixel of an uncoated portion as an edge line, from an electrode image.

However, according to the conventional edge detection device, when setting the brightness pixel value (gray value) of the uncoated portion, the position of the edge on the electrode image may be distorted to be different from the position of the actual edge. Accordingly, the conventional edge line detection device has the disadvantage of deteriorating measurement accuracy by incorrectly detecting the edge line.

### SUMMARY

### Technical Problem

To obviate one or more problems of the related art, embodiments of the present disclosure provide an edge detection apparatus.

To obviate one or more problems of the related art, embodiments of the present disclosure also provide an edge detection method.

To obviate one or more problems of the related art, embodiments of the present disclosure also provide an edge detection system.

### Technical Solution

In order to achieve the objective of the present disclosure, an apparatus for detecting edges of an uncoated portion within battery electrodes may include at least one processor; and a memory programmed thereon instructions that, when executed, are configured to cause the at least one processor to obtain a first electrode image of an electrode and a second electrode image of the electrode, wherein the first electrode image and the second electrode image are captured while the electrode is located at a same location; obtain pixel information of temporary edges on both sides of the uncoated portion in the electrode from the first electrode image; and an instruction to detect final edges on the both sides of the uncoated portion from the second electrode image based on the pixel information.

Here, the instructions may be configured to cause the at least one processor to adjust an exposure value of a camera so that a pixel brightness value of the uncoated portion in the first electrode image equals to a predetermined first threshold value.

In addition, the instructions may be configured to cause the at least one processor to adjust the exposure value of the camera so that the pixel brightness value of the uncoated portion in the second electrode image equals to a predetermined second threshold value, wherein the predetermined second threshold value is different from the predetermined first threshold value.

Furthermore, the pixel information of the temporary edges on the both sides of the uncoated portion may be obtained based on detection of the temporary edges on the both sides of the uncoated portion on the first electrode image.

Here, the instructions may be further configured to cause the at least one processor to detect a first temporary edge located on a first side of the uncoated portion on the first electrode image using a derivative mask filter and detect a second temporary edge located on a second side of the uncoated portion on the first electrode image using the derivative mask filter.

For example, the derivative mask filter may be a Sobel filter.

Meanwhile, the final edges may include a first final edge and a second final edge, and the instructions may be configured to cause the at least one processor to obtainpixel coordinate information of the first temporary edge and the second temporary edge and obtain a first virtual edge corresponding to a location of the first temporary edge and obtain a second virtual edge corresponding to a location of the second temporary edge determine a first inspection area and a second inspection area based on the first virtual edge and the second virtual edge, respectively, and detect the first final edge and the second final edge from the first inspection area and the second inspection area, respectively.

Furthermore, the instructions may be configured to cause the at least one processor to detect the first final edge and the second final edge based on first pixels having a maximum value in difference of a brightness value compared to neighboring pixels within the first inspection area and second pixels having a second maximum value in difference of brightness value compared to neighboring pixels within the second inspection area.

According to another embodiment of the present disclosure, a method for detecting edges of uncoated regions within battery electrodes may include acquiring a first electrode image and a second electrode image wherein the first electrode image and the second electrode image are captured while the electrode is located at a same location; obtaining pixel information of temporary edges on both sides of the uncoated portion in the electrode from the first electrode image; and detecting final edges on the both sides of the uncoated portion from the second electrode image based on the pixel information.

Here, the first electrode image may be captured by adjusting an exposure value of a camera so that a pixel brightness value of the uncoated portion in the first electrode image equals to a predetermined first threshold value.

In addition, the second electrode image may be captured by adjusting the exposure value of the camera so that the pixel brightness value of the uncoated portion in the second electrode image equals to a predetermined second threshold value, wherein the predetermined second threshold value is different from the predetermined first threshold value.

Furthermore, the method may further include detecting the temporary edges on the both sides of the uncoated portion on the first electrode image; wherein obtaining pixel coordinate information of the temporary edges is based on detection of the temporary edges.

Here, detecting the temporary edges may include detecting a first temporary edge located on a first side of the uncoated portion on the first electrode image using a derivative mask filter; and detecting a second temporary edge located on a second side of the uncoated portion on the first electrode image using the derivative mask filter.

For example, the derivative mask filter may be a Sobel filter.

Meanwhile, the final edges may include a first final edge and a second final edge, wherein detecting the final edges may include obtaining pixel coordinate information of a first temporary edge and a second temporary edge and obtaining a first virtual edge corresponding to a location of the first temporary edge and obtaining a second virtual edge corresponding to a location of the second temporary edgeand determining a first inspection area and a second inspection area based on the first virtual edge and the second virtual edge, respectively; and detecting the first final edge and the second final edge from the first inspection area and the second inspection area, respectively.

Furthermore, detecting the first final edge and the second final edge may include detecting pixels having a first maximum value in difference of brightness value compared to neighboring pixels within the first inspection area, as the first final edge; and detecting pixels having a second maximum value in difference of brightness value compared to neighboring pixels within the second inspection area, as the second final edge.

According to another embodiment of the present disclosure, a system for detecting edges of an uncoated portion within battery electrodes may include a camera configured to generate a first electrode image and a second electrode image wherein the first electrode image and the second electrode image are captured while the electrode is located at a same location with different brightness values, by adjusting an exposure value of the camera and an edge detection apparatus configured to obtain the first electrode image and the second electrode image from the camera, detect pixel information of temporary edges on both sides of the uncoated portion in the electrode from the first electrode image, and detect final edges on both sides of the uncoated portion from the second electrode image based on the pixel information.

### Advantageous Effects

The edge detection apparatus and method according to embodiments of the present invention may acquire a first electrode image and a second electrode image with different brightness values in which the same electrode is captured and detect final edges of the uncoated portion from the second electrode image based on pixel coordinate information of edges of the uncoated portion obtained from the first electrode image, thereby improving detection accuracy of edge detection.

### BRIEF DESCRIPTION OF THE DRAWINGS

FIG. 1 is an electrode image of a general edge detection device.

FIG. 2 is a graph of edge position change according to brightness value setting of a general edge detection device.

FIG. 3 is a block diagram of an edge detection system according to embodiments of the present invention.

FIG. 4 is a block diagram of an edge detection apparatus according to embodiments of the present invention.

FIG. 5 is a flowchart of an edge detection method using the edge detection apparatus according to embodiments of the present invention.

FIG. 6 is a conceptual diagram of the edge detection method according to embodiments of the present invention.

FIG. 7 is a flowchart for explaining a method of detecting final edges of the edge detection method according to embodiments of the present invention.

FIG. 8 is an image showing pixel coordinates of a second final edge of the edge detection apparatus according to an experimental example of the present invention.

1000: camera
5000: edge detection apparatus
100: memory
200: processor
300: transceiver
400: input interface
500: output interface
600: storage device
700: bus

### DETAILED DESCRIPTION

The present invention may be modified in various forms and have various embodiments, and specific embodiments thereof are shown by way of example in the drawings and will be described in detail below. It should be understood, however, that there is no intent to limit the present invention to the specific embodiments, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes combinations of a plurality of associated listed items or any of the plurality of associated listed items.

It will be understood that when an element is referred to as being “coupled” or “connected” to another element, it can be directly coupled or connected to the other element or an intervening element may be present. In contrast, when an element is referred to as being “directly coupled” or “directly connected” to another element, there is no intervening element present.

Terms used in the present application are used only to describe specific embodiments, and are not intended to limit the present invention. A singular form includes a plural form if there is no clearly opposite meaning in the context. In the present application, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

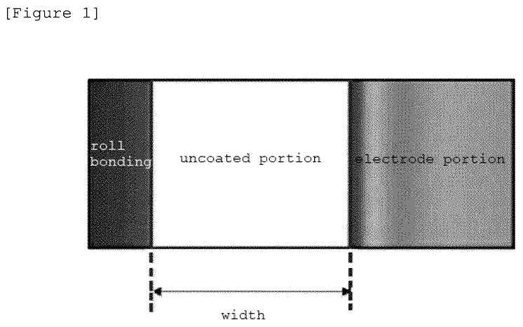

FIG. 1 is an electrode image of a general edge detection device.

Referring to FIG. 1, an electrode applied to a cylindrical battery can be divided into a roll bonding area, a electrode portion, and an uncoated portion.

In more detail, the roll bonding area may be an area that is joined to a roll of a cylindrical battery, and the electrode portion may be an area which is coated with electrode active material for negative and positive electrodes. Additionally, the uncoated portion may be an area in which the electrode active material is not coated.

In a slitting process, the width of the electrode portion and the width of the uncoated portion are calculated so that batteries with the same specification are formed, and the electrodes can be cut uniformly within a margin of error according to the calculated result.

Accordingly, it is necessary to clearly detect the boundaries between the roll bonding area, the electrode portion, and the uncoated portion, in order to calculate the widths of the electrode portion and the uncoated portion. In other words, it is necessary to clearly detect the edges on both sides of the uncoated area.

A general edge detection device detects edges of the uncoated portion based on an electrode image obtained from a camera.

Here, the exposure value of the camera may be set so that a brightness pixel value (Gray Value) of the uncoated portion on the electrode image has a specific value. Accordingly, a general edge detection device detects pixels corresponding to a preset threshold brightness value on an electrode image as an edge.

To be more specific, a general edge detection device can detect a boundary of an uncoated portion based on an electrode image captured by adjusting an exposure value of a camera so that the brightness pixel value (Gray Value) of the uncoated portion is 255.

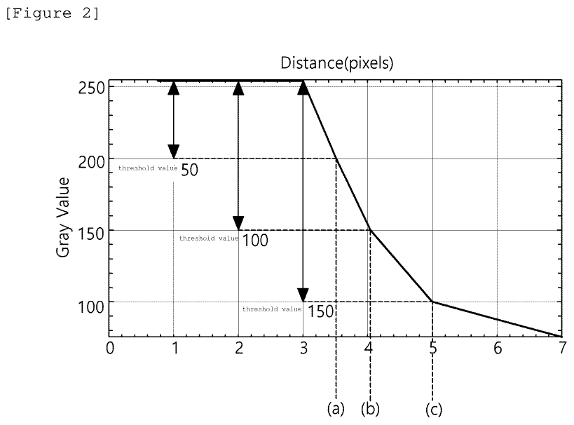

FIG. 2 is a graph of edge position change according to brightness value setting of a general edge detection device.

Referring to FIG. 2, a general edge detection device detects pixels corresponding to a preset threshold brightness value as an edge based on an electrode image.

However, a general edge detection device has the disadvantage of requiring a reset of the threshold value for edge detection of the uncoated portion when a saturation value changes due to a change in composition of insulating liquid.

Accordingly, a general edge detection device has the disadvantage of deteriorating precision when measuring the widths of the electrode portion and the uncoated portion by incorrectly detecting the edge positions of the uncoated part.

In addition, according a general edge detection device, the position of the edges of the uncoated portion may vary depending on a change in the threshold brightness value.

For example, if the threshold brightness value is defined as 50, difference between a position of the edge detected by a general boundary detection device and the actual edge may be about 3.6 pixels.

For another example, when the threshold brightness value is defined as 100, the difference between a position of the edge detected by a general boundary detection device and the actual edge may be about 4 pixels.

For another example, when the threshold brightness value is defined as 150, the difference between a position of the edge detected by a general boundary detection device and the actual edge may be about 5 pixels.

The present invention was developed to solve this technical problem. The present invention may detect edges of the uncoated portion using the first electrode image and the second electrode image taken at different brightness values by adjusting the exposure of the camera, thereby improving accuracy of edge detection.

Hereinafter, preferred embodiments according to the present invention will be described in detail with reference to the attached drawings.

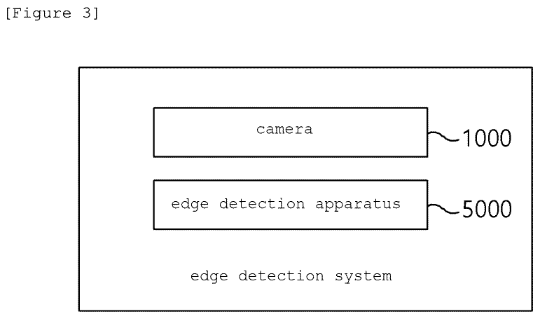

FIG. 3 is a block diagram of an edge detection system according to embodiments of the present invention.

Referring to FIG. 3, the edge detection system may edge detection apparatus include a camera (imaging device) 1000 and an edge detection apparatus 5000.

To be more specific, the camera 1000 may be installed at a site where an electrode preparation process is performed. In other words, the camera 1000 may be fixedly installed in an equipment where a plurality of electrodes are sequentially moved. Accordingly, the camera 1000 may acquire a plurality of electrode images by individually imaging a plurality of electrodes passing through the equipment.

Meanwhile, a plurality of cameras 1000 may be provided. More specifically, the camera 1000 may include a first camera and a second camera that photograph the same point.

The first camera and the second camera may have different exposure values.

According to an embodiment, the exposure value of the first camera may be preset so that the pixel brightness value of the uncoated portion corresponds to a first threshold value. Accordingly, the first camera may acquire at least one first electrode image by imaging a plurality of electrodes passing through a specific point. For example, the first threshold may be 255.

In addition, the exposure value of the second camera may be preset so that the pixel brightness value of the uncoated portion corresponds to a second threshold value. Accordingly, the second camera may acquire at least one second electrode image by imaging a plurality of electrodes passing through the specific point. For example, the second threshold may be 200.

In other words, the first electrode image and the second electrode image may be images taken of the same electrode at the same point.

The edge detection apparatus 5000 may be linked with at least one camera 1000 to obtain a first electrode image and a second electrode image from the camera 1000. However, the edge detection apparatus 5000 is not limited to this and may acquire at least one first electrode image and at least one second electrode image through other various ways.

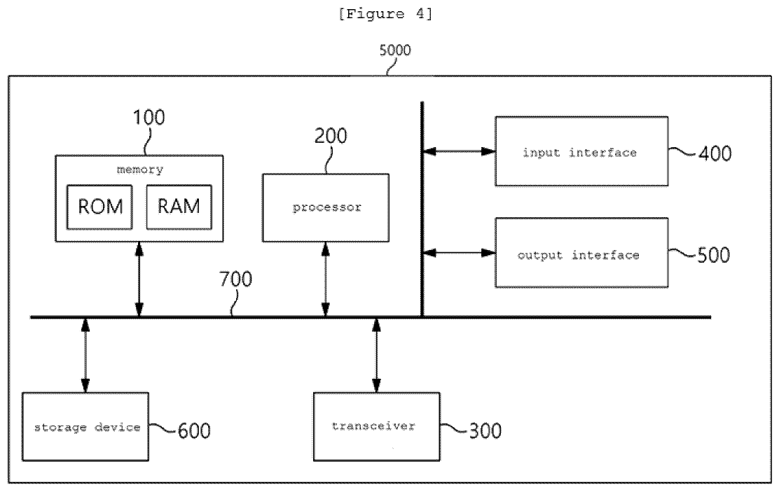

Thereafter, the edge detection apparatus 5000 may detect temporary edges based on the first electrode image and detect final edges based on the detected temporary edges. Accordingly, the edge detection apparatus 5000 according to embodiments of the present invention has improved edge detection accuracy of the uncoated area, and can precisely measure the width of the uncoated portion and the electrode part. The configuration of the edge detection apparatus 5000 will be described in more detail with reference to FIG. 4 below.

FIG. 4 is a block diagram of an edge detection apparatus according to embodiments of the present invention.

Describing the edge detection apparatus 5000 in more detail by configuration with reference to FIG. 4, the edge detection apparatus 5000 may include a memory 100, a processor 200, a transceiver 300, an input interface 400, an output interface 500, and a storage device 600.

According to embodiments, respective components 100, 200, 300, 400, 500, and 600 included in the edge detection apparatus are connected by a bus 700 and can communicate with each other.

Among the components 100, 200, 300, 400, 500, and 600, the memory 100 and the storage device 600 may include at least one of a volatile storage medium and a non-volatile storage medium. For example, the memory 100 and the storage device 600 may include at least one of read only memory (ROM) and random access memory (RAM).

Among these, the memory 100 may include at least one instruction executed by the processor 200.

According to embodiments, the at least one instruction may include an instruction to obtain a first electrode image and a second electrode image in which the same electrode located at the same point is captured; an instruction to detect pixel information of temporary edges on both sides of an uncoated portion in the electrode from the first electrode image; and an instruction to detect final edges on both sides of the uncoated portion from the second electrode image based on the pixel information.

Here, the first electrode image may be an image captured by adjusting an exposure value of a camera so that a pixel brightness value of the uncoated portion in the first electrode image is a predetermined first threshold value.

In addition, the second electrode image may be an image captured by adjusting an exposure value of a camera so that a pixel brightness value of the uncoated portion in the second electrode image is a second threshold value, wherein the second threshold value is different from the first threshold value.

Furthermore, the instruction to detect pixel information of temporary edges on both sides of the uncoated portion may include an instruction to detect the temporary edges on both sides of the uncoated portion on the first electrode image; and an instruction to obtain pixel coordinate information of the temporary edges.

Here, the instruction to detect the temporary edges may include an instruction to detect a first temporary edge located on one side of the uncoated portion on the first electrode image using a derivative mask filter and an instruction to detect a second temporary edge located on the other side of the uncoated portion on the first electrode image using the derivative mask filter.

For example, the derivative mask filter may be a Sobel filter.

Meanwhile, the instruction to detect final edges may include an instruction to identify pixel coordinate information of the first temporary edge and the second temporary edge and obtain a first virtual edge and a second virtual edge which are located at the same points on the second electrode image where the first temporary edge and the second temporary edge are located and an instruction to determine a first inspection area and a second inspection area based on the first virtual edge and the second virtual edge, respectively, and detect a first final edge and a second final edge from the first inspection area and the second inspection area, respectively.

Furthermore, the instruction to detect the first final edge and the second final edge may include an instruction to detect pixels having the maximum value in difference of brightness value (gray level) compared to neighboring pixels within the first inspection area, as the first final edge and an instruction to detect pixels having the maximum value in difference of brightness value (gray level) compared to neighboring pixels within the second inspection area, as the second final edge.

Meanwhile, the processor 200 may refer to a central processing unit (CPU), a graphics processing unit (GPU), or a dedicated processor on which methods according to embodiments of the present invention are performed.

As described above, the processor 200 may execute at least one program command stored in the memory 100.

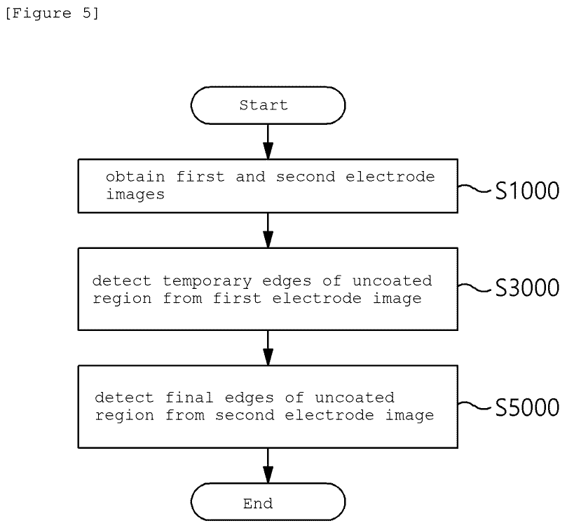

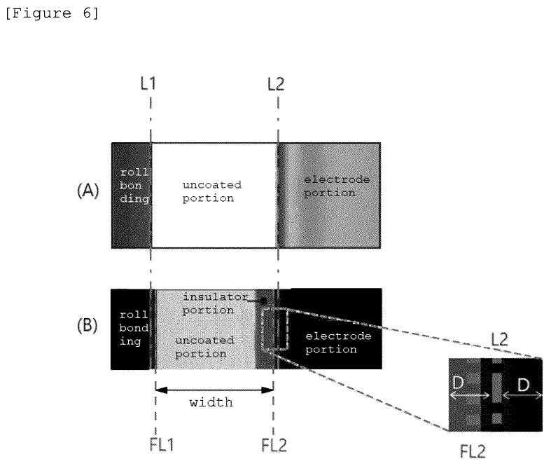

FIG. 5 is a flowchart of an edge detection method using the edge detection apparatus according to embodiments of the present invention and FIG. 6 is a conceptual diagram of the edge detection method according to embodiments of the present invention.

Referring to FIGS. 5 and 6, the edge detection apparatus 5000 may obtain a first electrode image (A) and a second electrode image (B) (S1000).

As described above, the first electrode image (A) and the second electrode image (B) may be images taken of the same electrode located at the same point.

Here, the pixel brightness value of the uncoated region in the first electrode image (A) may be a preset first threshold value, and the pixel brightness value of the uncoated region in the second electrode image (B) may be a preset second threshold value.

Afterwards, the edge detection apparatus 5000 may detect temporary edges using the first electrode image (A) (S3000).

In more detail, the edge detection apparatus 5000 may detect the first temporary edge L1 and the second temporary edge L2. Here, the first temporary edge (L1) may be an edge located on one side of the uncoated region on the first electrode image (A), and the second temporary edge (L2) may be an edge located on the other side of the uncoated region on the first electrode image (A). In other words, the first temporary edge (L1) may be an edge located between the roll bonding area and the uncoated region, and the second temporary edge (L2) may be an edge located between the uncoated portion and the electrode portion.

According to an embodiment, the boundary detection apparatus 5000 may detect the first temporary edge L1 and the second temporary edge L2 using a derivative mask filter. For example, the derivative mask filter may be a Sobel filter.

For example, the boundary detection apparatus 5000 may use a Sobel filter disclosed in [Equation 1] and [Equation 2] below to obtain pixel coordinate information of the first temporary edge L1 and the second temporary edge L2 from the first electrode image A.

$${G}_{x =} [ \begin{matrix}- 1 & 0 & 1 \\ - 2 & 0 & 2 \\ - 1 & 0 & 1\end{matrix} ] \qquad [ Equation 1 ]$$

$$Gx : x - direction partial derivative mask$$

$${G}_{y =} [ \begin{matrix}- 1 & - 2 & - 1 \\ 0 & 0 & 0 \\ 1 & 2 & 1\end{matrix} ] \qquad [ Equation 2 ]$$

$$Gy : y - direction partial derivative mask$$

Thereafter, the edge detection apparatus 5000 may detect final edges from the second electrode image B based on the pixel coordinate information of the first temporary edge L1 and the second temporary edge L2 detected from the first electrode image A (S5000).

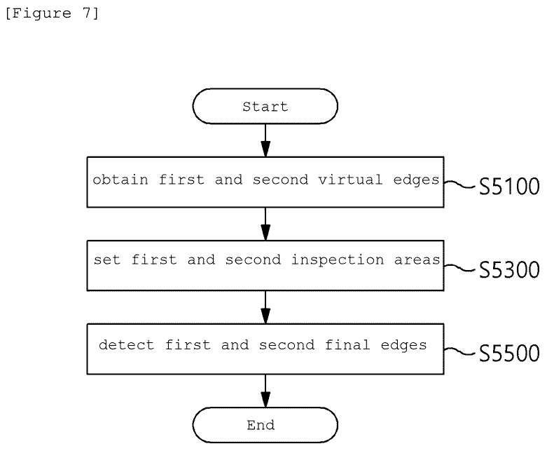

FIG. 7 is a flowchart for explaining a method of detecting final edges of the edge detection method according to embodiments of the present invention.

Referring to FIG. 7, the edge detection apparatus 5000 may obtain virtual edges from the second electrode image B (S5100). Here, the virtual edges (L1, L2 in FIG. 6(B)) may be edges corresponding to pixel coordinate information of the first temporary edge (L1 in FIG. 6(A)) and the second temporary edge (L2 in FIG. 6(A)) which are obtained based on the first electrode image (A).

Thereafter, the edge detection apparatus 5000 may set inspection areas for detecting final edges based on the first virtual edge and the second virtual edge in the second electrode image B (S5300).

According to embodiments, the inspection area may include a first inspection area and a second inspection area. The first inspection area may be an area with a predetermined gap D in the left and the right directions based on the first virtual edge, as shown in FIG. 6.

Additionally, the second inspection area may be an area with a predetermined gap (D) in the left and the right directions, respectively, based on the second virtual edge. For example, the predetermined interval (D) may be 40 pixels.

Thereafter, the edge detection apparatus 5000 may obtain the final edges FL1 and FL2 using differences in gray level within the first inspection area and the second inspection area (S5500).

More specifically, the edge detection apparatus 5000 may obtain the first final edge (FL1) having the maximum value among the gray level differences within the first inspection area based on the first virtual edge.

In addition, the edge detection apparatus 5000 may obtain the second final edge FL2 having the maximum value among the gray level differences within the second inspection area based on the second virtual edge.

Accordingly, the edge detection apparatus of the present invention can be used to detect the widths of the uncoated region and the electrode region within the electrode by obtaining the final edges (FL1, FL2) of the uncoated region from the second electrode image.

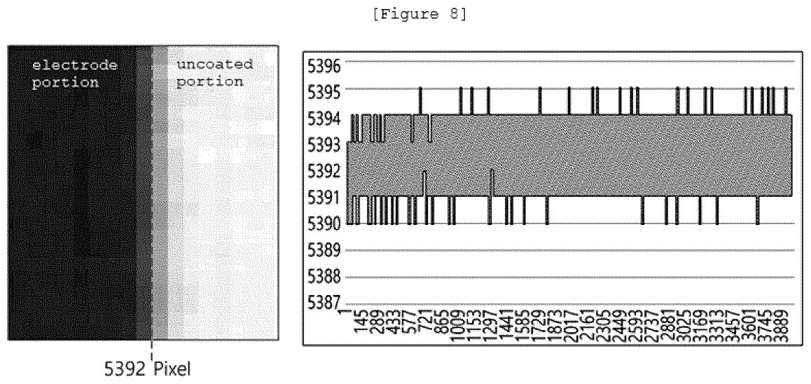

FIG. 8 is an image showing pixel coordinates of a second final edge of the edge detection apparatus according to an experimental example of the present invention.

FIG. 8 shows that the edge error of the final edge which is measured by the edge detection apparatus according to the experimental example of the present invention falls within 2 pixels, when the pixel coordinates where the actual edge on the second electrode image is located is 5392 pixel.

The edge detection apparatus and method according to embodiments of the present invention have been described above.

The edge detection apparatus and method according to embodiments of the present invention may acquire a first electrode image and a second electrode image with different brightness values in which the same electrode is captured and detect final edges of the uncoated portion from the second electrode image based on pixel coordinate information of edges of the uncoated portion obtained from the first electrode image, thereby improving detection accuracy of edge detection.

The operations of the method according to the embodiments of the present invention may be implemented as a computer-readable program or code on a computer-readable recording medium. The computer-readable recording medium includes all types of recording devices in which data readable by a computer system is stored. In addition, the computer-readable recording medium may be distributed in a network-connected computer system to store and execute computer-readable programs or codes in a distributed manner.

In addition, the computer-readable recording medium may include hardware devices specially configured to store and execute program instructions, such as ROM, RAM, flash memory, etc. The program instructions may include not only machine language code created by a compiler, but also high-level language code that can be executed by a computer using an interpreter.

Although some aspects of the invention have been described in the context of the apparatus, it may also represent a description according to a corresponding method, wherein a block or apparatus corresponds to a method step or feature of a method step. Similarly, aspects described in the context of a method may also represent a feature of a corresponding block or item or a corresponding apparatus. Some or all of the method steps may be performed by (or using) a hardware device, such as, for example, a microprocessor, a programmable computer, or an electronic circuit. In some embodiments, one or more of the most important method steps may be performed by such an apparatus.

The forgoing, the present invention has been described with reference to the exemplary embodiment of the present invention, but those skilled in the art may appreciate that the present invention may be variously corrected and changed within the range without departing from the spirit and the area of the present invention described in the appending claims.

1. An apparatus for detecting edges of an uncoated portion within battery electrodes, the apparatus comprising:
at least one processor; and
memory having programmed thereon instructions that, when executed, are configured to cause the at least one processor to:
obtain a first electrode image of an electrode and a second electrode image of the electrode, wherein the first electrode image and the second electrode image are captured while the electrode is located at a same location;
obtain pixel information of temporary edges on both sides of the uncoated portion in the electrode from the first electrode image; and
detect final edges on the both sides of the uncoated portion from the second electrode image based on the pixel information.

2. The apparatus of claim 1, wherein the instructions are configured to cause the at least one processor to adjust an exposure value of a camera so that a pixel brightness value of the uncoated portion in the first electrode image equals to a predetermined first threshold value.

3. The apparatus of claim 2, wherein the instructions are configured to cause the at least one processor to adjust the exposure value of the camera so that the pixel brightness value of the uncoated portion in the second electrode image equals to a predetermined second threshold value, wherein the-predetermined second threshold value is different from the predetermined first threshold value.

4. The apparatus of claim 1, wherein the pixel information of the temporary edges on the both sides of the uncoated portion is obtained based on:
detection of the temporary edges on the both sides of the uncoated portion on the first electrode image.

5. The apparatus of claim 4, wherein the instructions are configured to cause the at least one processor to:
detect a first temporary edge located on a first side of the uncoated portion on the first electrode image using a derivative mask filter and
detect a second temporary edge located on a second the of the uncoated portion on the first electrode image using the derivative mask filter.

6. The apparatus of claim 5, wherein the derivative mask filter is a Sobel filter.

7. The apparatus of claim 1, wherein the final edges include a first final edge and a second final edge, and wherein the instructions are configured to cause the at least one processor to
obtain pixel coordinate information of the first temporary edge and the second temporary edge,
obtain a first virtual edge corresponding to a location of the first temporary edge; obtain a second virtual edge corresponding to a location of the second temporary edge;
determine a first inspection area and a second inspection area based on the first virtual edge and the second virtual edge, respectively,
detect the first final edge and the second final edge from the first inspection area and the second inspection area, respectively.

8. The apparatus of claim 7, wherein the instructions are configured to cause the at least one processor to detect the first final edge and the second final edge based on:
first pixels having a first maximum value in difference of a brightness value compared to neighboring pixels within the first inspection area; and
second pixels having a second maximum value in difference of brightness value compared to neighboring pixels within the second inspection area.

9. A method for detecting edges of uncoated regions within battery electrodes, the method comprising:
acquiring a first electrode image and a second electrode image wherein the first electrode image and the second electrode image are captured while the electrode is located at a same location;
obtaining pixel information of temporary edges on both sides of the uncoated portion in the electrode from the first electrode image; and
detecting final edges on the both sides of the uncoated portion from the second electrode image based on the pixel information.

10. The method of claim 9, wherein the first electrode image is captured by adjusting an exposure value of a camera so that a pixel brightness value of the uncoated portion in the first electrode image equals to a predetermined first threshold value.

11. The method of claim 10, wherein the second electrode image is captured by adjusting the exposure value of the camera so that the pixel brightness value of the uncoated portion in the second electrode image equals to a predetermined second threshold value, wherein the predetermined second threshold value is different from the predetermined first threshold value.

12. The method of claim 9, further comprising:
detecting the temporary edges on the both sides of the uncoated portion on the first electrode image; and
wherein obtaining pixel coordinate information of the temporary edges is based on detection of the temporary edges.

13. The method of claim 12, wherein detecting the temporary edges includes:
detecting a first temporary edge located on a first side of the uncoated portion on the first electrode image using a derivative mask filter; and
detecting a second temporary edge located on a second side of the uncoated portion on the first electrode image using the derivative mask filter.

14. The method of claim 13, wherein the derivative mask filter is a Sobel filter.

15. The method of claim 9, wherein the final edges include a first final edge and a second final edge, wherein detecting the final edges includes:
obtaining pixel coordinate information of a first temporary edge and a second temporary edge;
obtaining a first virtual edge corresponding to a location of the first temporary edge;
obtaining a second virtual edge corresponding to a location of the second temporary edge; and
determining a first inspection area and a second inspection area based on the first virtual edge and the second virtual edge, respectively; and
detecting the first final edge and the second final edge from the first inspection area and the second inspection area, respectively.

16. The method of claim 15, wherein detecting the first final edge and the second final edge includes:
detecting pixels having a first maximum value in difference of brightness value compared to neighboring pixels within the first inspection area, as the first final edge; and
detecting pixels having a second maximum value in difference of brightness value compared to neighboring pixels within the second inspection area, as the second final edge.

17. A system for detecting edges of an uncoated portion within battery electrodes, the system comprising:
a camera configured to generate a first electrode image and a second electrode image, wherein the first electrode image and the second electrode image are captured while the electrode is located at a same location with different brightness values, by adjusting an exposure value of the camera; and
an edge detection apparatus configured to obtain the first electrode image and the second electrode image from the camera, to detect pixel information of temporary edges on both sides of the uncoated portion in the electrode from the first electrode image, and detect final edges on both sides of the uncoated portion from the second electrode image based on the pixel information.
